(19) United States
(12) Patent Application Publication
(10) Pub. No.: US 2025/0225598 A1
(43) Pub. Date: Jul. 10, 2025

(54) AI-DRIVEN REAL ESTATE PROPERTY AREAS SEARCH, PROPERTY GRANULAR COMPONENTS, USAGE STORIES AND BACKSTORIES ANALYSIS, MATCHING SYSTEM AND RELATED METHODS

(71) Applicant: Talega IP Holding LLC, Sheridan, WY (US)

(72) Inventor: Bruce Demetrius Hiatt, Las Vegas, NV (US)

(73) Assignee: Talega IP Holding LLC, Sheridan, WY (US)

(21) Appl. No.: 18/969,431

(22) Filed: Dec. 5, 2024

Related U.S. Application Data
(60) Provisional application No. 63/617,677, filed on Jan. 4, 2024.

(51) Int. Cl. G06Q 50/16; G06F 40/40; G06Q 30/0601; G06V 10/70

(52) U.S. Cl. CPC G06Q 50/16; G06Q 30/0627; G06F 40/40; G06V 10/70

(57) ABSTRACT

A computer-implemented method and system for searching and matching real estate properties to a buyer's desired property criteria using artificial intelligence (AI) is disclosed. The method involves analyzing property data, including images, videos, and textual descriptions, to extract insights and identify granular property elements. It generates granular property content based on the analyzed data and matches the buyer's criteria with properties to determine the best matches. The system presents these properties to the buyer and includes an AI-driven property interaction system for engaging with the buyer, providing interactive information about the properties. Additionally, a luxury property database system stores components, listings, tours, and stories to facilitate the search and matching process.

### CROSS REFERENCE TO RELATED APPLICATIONS

This application claims priority to Provisional Patent Application U.S. 63/617,677 filed on Jan. 4, 2024, the entire disclosure of which is hereby incorporated by reference and relied upon.

### TECHNICAL FIELD

AI-driven real estate property areas search, granular property components, usage stories and backstories analysis, matching, visualization and related methods.

### BACKGROUND

The real estate industry has traditionally relied on human agents to facilitate property transactions, provide market insights, and match buyers with suitable properties. This process, while effective, can be time-consuming and may not always cater to the specific emotional and practical needs of luxury property buyers. As the demand for luxury real estate continues to grow, there is an increasing need for more efficient and personalized property search and matching solutions.

In recent years, advancements in artificial intelligence (AI) have opened new possibilities for transforming the real estate market. AI technologies, such as machine vision and natural language processing, have the potential to analyze vast amounts of data, including images, videos, and textual descriptions, to extract meaningful insights about properties. These technologies can enhance the property search experience by providing more granular and personalized results, addressing the unique preferences and desires of luxury property buyers. As the luxury real estate market evolves, there is a pressing need for innovative solutions that leverage AI to improve the efficiency and personalization of property searches, ultimately enhancing the overall buying experience.

### SUMMARY

In accordance with embodiments, a computer-implemented method is provided for searching and matching real estate properties to a buyer's desired property criteria using artificial intelligence (AI). The method involves analyzing property data, including images, videos, and textual descriptions, to extract insights and identify granular property elements. Granular property content is generated based on the analyzed property data. The method further includes receiving a buyer's desired property criteria and matching these criteria with properties based on the analyzed data and generated content to determine the best matching properties. The best matching properties are then presented to the buyer.

In accordance with other embodiments, a system is provided for searching and matching real estate properties to a buyer's desired property criteria using AI. The system comprises an AI-driven property analysis and matching system configured to analyze property data, generate granular property content, receive a buyer's desired property criteria, match these criteria with properties, and present the best matching properties to the buyer. Additionally, the system includes an Al-driven property interaction system for engaging with the buyer and providing interactive information about the properties, and a luxury property database system for storing luxury property components, properties for sale listings, property tours, and stories.

In yet other embodiments, the AI-driven property analysis and matching system utilizes machine vision to identify granular property elements from images and videos. The system also generates granular property content using a large language model and generative AI. The buyer's desired property criteria may include desired property granular components, property areas usage stories, and backstories. The matching process is based on the analyzed property data, generated content, and the buyer's criteria to determine the best matching properties. Presenting the best matching properties includes providing property granular components, property areas usage stories, and backstories.

In further embodiments, the AI-driven property interaction system engages with the buyer using a conversational AI system, an avatar, or a hologram, facilitating a dynamic and engaging dialogue to provide interactive information about the properties. The luxury property database system stores luxury property components, properties for sale listings, property tours, and stories to facilitate search and matching with the buyer's criteria.

In additional embodiments, the AI-driven property analysis and matching system, the AI-driven property interaction system, and the luxury property database system work together to manifest an AI-driven real estate property search and matching system that considers both practical and emotional needs of the buyer.

### BRIEF DESCRIPTION OF THE SEVERAL VIEWS OF THE DRAWINGS

FIG. 1 illustrates, in a flowchart, the operations of an AI-driven property matching system in accordance with certain embodiments.

FIG. 2 illustrates a block diagram of an AI-driven real estate property search and matching system, showcasing its main components.

FIG. 3 illustrates a detailed floor plan of a property, highlighting various rooms and exterior areas.

FIG. 4 shows a system of interconnected databases for storing luxury property components, listings, and stories, facilitating AI-driven matching with buyer preferences.

### DETAILED DESCRIPTION

This disclosure provides a computer-implemented method and system for searching and matching real estate properties to a buyer's desired property criteria using artificial intelligence (AI). The AI-driven property analysis and matching system may analyze property data, including images, videos, and textual descriptions, to extract insights and identify granular property elements. This system can generate granular property content using a large language model and generative AI, which may enhance the detail and personalization of property information. The system may receive a buyer's desired property criteria and match these criteria with properties based on the analyzed data and generated content to determine the best matching properties. The AI-driven property interaction system can engage with the buyer, providing interactive information about the properties through various mediums such as a conversational AI system, avatar, or hologram. Additionally, a luxury property database system may store luxury property components, properties for sale listings, property tours, and stories, facilitating AI-driven matching with potential buyers. This approach can address both the practical and emotional needs of buyers in the luxury real estate market, offering a more efficient and personalized property buying experience.

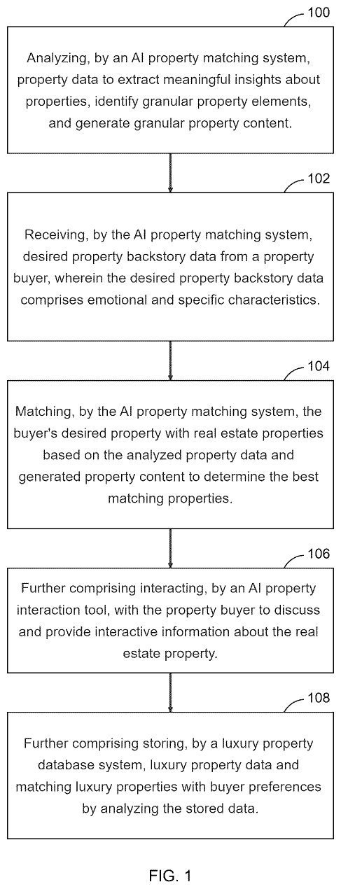

FIG. 1 is a flowchart illustrating a method in step 100 for analyzing property data to extract meaningful insights about properties, according to an embodiment. At step 100, the AI property analysis tool may analyze property data, which can include images, videos, and textual descriptions, to extract insights and identify granular property elements. This analysis may involve the use of machine vision to identify these elements from the images and videos. The AI property analysis tool may also generate granular property content using a large language model and generative AI, which can create detailed property content. The AI-driven property analysis and matching system may utilize these capabilities to generate property content based on the analyzed property data. This process may be part of a larger AI-driven real estate property search and matching system that considers both practical and emotional needs of the buyer. The AI property analysis tool may work in conjunction with other components, such as the AI-driven property interaction system and the luxury property database system, to facilitate a comprehensive property search and matching process. The integration of these systems may enable the extraction of meaningful insights about properties and the creation of detailed property content, which can be used to match the buyer's desired property criteria with available properties.

In step 102, the AI-driven property analysis and matching system may receive desired property backstory data from a property buyer. This data may encompass emotional and specific characteristics that the buyer is interested in. The AI-driven property analysis and matching system may be configured to handle such data, potentially allowing for a more personalized property search experience. The system may utilize advanced AI technologies, including machine vision and natural language processing, to analyze and interpret the backstory data. This process may involve the extraction of insights and the identification of granular property elements that align with the buyer's emotional and specific preferences. The Al property analysis tool may play a role in this step by analyzing vast amounts of data, including images, videos, and textual descriptions, to generate detailed property content. This content may then be used to match the buyer's desired property areas with luxury real estate properties, potentially determining the best matching properties. The AI-driven property analysis and matching system may also integrate with other components, such as the AI-driven property interaction system and the luxury property database system, to provide a comprehensive property search and matching experience that considers both the practical and emotional needs of the buyer. This integration may facilitate a dynamic and engaging dialogue with the consumer, enhancing the overall property buying experience.

In the context of Step 104, the process may involve the AI property analysis tool potentially matching the buyer's desired property with real estate properties. This matching may be based on the analyzed property data and the generated property content, which could be derived from various AI technologies. The AI property analysis tool may utilize machine vision to analyze vast amounts of data, including images, videos, and textual descriptions, to extract meaningful insights and identify granular property elements. Additionally, the tool may generate granular property content using a large language model and generative AI, which could aid in creating detailed property content. The matching process may aim to determine the best matching properties by aligning the buyer's desired property areas with luxury real estate properties. This alignment may be facilitated by the Al property analysis tool's ability to analyze and generate content that resonates with the buyer's criteria. The potential outcome of this step may be the identification of properties that best match the buyer's preferences, thereby enhancing the property search experience.

In step 106, the AI property interaction tool may engage with the property buyer to discuss and provide interactive information about the real estate property. This interaction may involve the use of various mediums, such as a conversational AI system, an avatar, or a hologram, to facilitate a dynamic and engaging dialogue with the consumer. The AI-driven property interaction system may be designed to engage with the buyer and provide interactive information about the properties, potentially enhancing the buyer's understanding and experience. The interaction may be tailored to address both the practical and emotional needs of the buyer, as the system may work to provide detailed insights and information about the property in question. The AI property interaction tool may utilize advanced technologies to create a more personalized and immersive experience for the buyer, potentially leading to a more informed decision-making process. The system may be configured to adapt to the buyer's preferences and provide relevant information in a manner that is both engaging and informative. This step may ensure that the buyer receives a comprehensive understanding of the property, which may ultimately influence their purchasing decision.

In step 108, the process may involve storing luxury property data and matching luxury properties with buyer preferences by analyzing the stored data. This step may be facilitated by a luxury property database system, which can store various components such as luxury property components, properties for sale listings, property tours, and stories. The database system may be interconnected, allowing for a comprehensive storage solution that can capture and store real estate luxury property granular elements. This storage capability may facilitate AI-driven matching with potential buyers by providing a repository of detailed property data that can be analyzed to determine the best matching properties. The stored data may include granular luxury property components, backstories, and property areas owner usage, which can be utilized to match the buyer's desired property criteria with available properties. The AI-driven database system for real estate matching may work in conjunction with other systems to ensure that both practical and emotional needs of the buyer are considered. This integration may allow for a more personalized and efficient property search experience, where the buyer's preferences are matched with the most suitable luxury properties based on the analyzed and stored data.

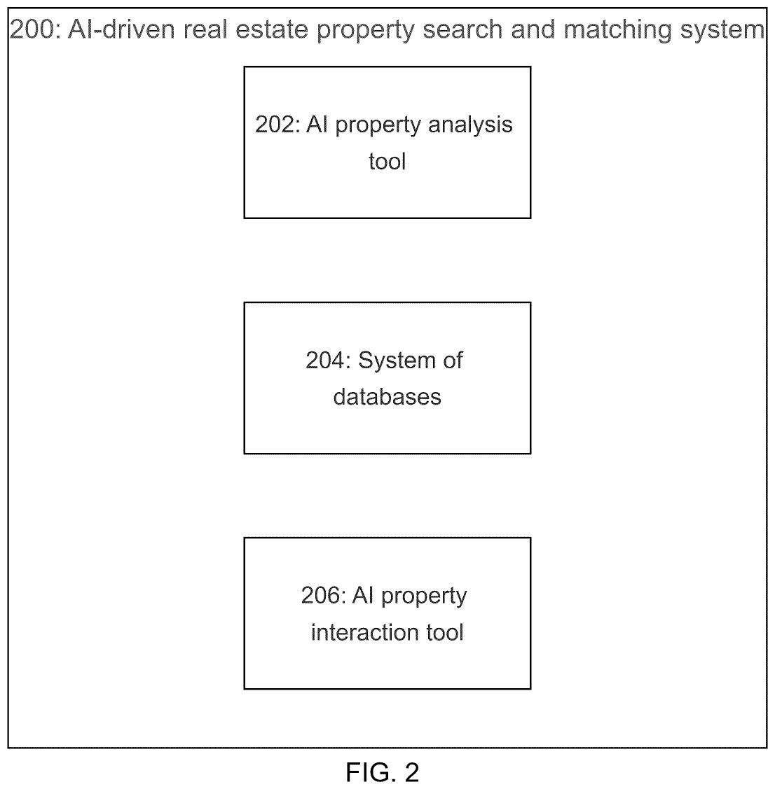

FIG. 2 illustrates the AI property analysis tool, which may be a component in the AI-driven real estate property search and matching system. This tool may analyze property data, including images, videos, and textual descriptions, to extract insights and identify granular property elements. The analysis may be conducted using machine vision, which can identify these elements from the visual data. Additionally, the AI property analysis tool may generate granular property content using a large language model and generative AI, creating detailed property content that may be used for matching purposes.

The AI property analysis tool may receive a buyer's desired property criteria, which may include desired property granular components, property areas usage stories, and backstories. By matching these criteria with properties based on the analyzed property data and generated property content, the tool may determine the best matching properties. This matching process may involve correlating the buyer's criteria with the identified property elements and generated content to ensure a comprehensive match.

Once the best matching properties are determined, they may be presented to the buyer. This presentation may include providing property granular components, property areas usage stories, and backstories of the best matching properties, offering the buyer a detailed view of the potential properties. The AI property analysis tool may work in conjunction with other components, such as the AI-driven property interaction system and the luxury property database system, to provide a seamless and integrated property search experience that considers both the practical and emotional needs of the buyer.

The system/component 204, identified as the System of databases, may serve as an element in the AI-driven real estate property search and matching system. This system of databases may be responsible for storing luxury property components, properties for sale listings, and property tours and stories. The luxury property database system may store these elements to facilitate AI-driven matching with potential buyers. The databases may capture and store real estate luxury property granular elements, which may include property areas owner usage and backstories in various formats, including visual. This storage capability may enable future searches and matching with a buyer's desired property criteria.

The system of databases may work in conjunction with other components, such as the AI property analysis tool and the AI property interaction tool, to manifest a comprehensive AI-driven real estate property search and matching system. The AI property analysis tool may analyze vast amounts of data, including images, videos, and textual descriptions, to extract meaningful insights about properties. It may utilize machine vision to identify granular property elements from images and videos and generate granular property content using a large language model and generative AI. This analysis may be essential for determining the best matching properties based on the buyer's desired property criteria.

The AI property interaction tool may engage with the luxury property buyer to discuss and provide interactive information about the luxury real estate property granular components, property areas usage stories, and backstories. This interaction may involve the use of a conversational AI system, an avatar, or a hologram, facilitating a dynamic and engaging dialogue with the consumer. The integration of these systems may consider both the practical and emotional needs of the buyer, enhancing the overall property search and matching experience.

The system of databases may also facilitate the storage of luxury property components, listings, and stories, which may be crucial for the AI-driven matching process. By capturing and storing detailed property data, the system of databases may enable a more efficient and personalized property search experience for luxury real estate buyers. This approach may ensure that the best matching properties are presented to the buyer, aligning with their desired property criteria and enhancing their property buying journey.

The AI property interaction tool, identified as component 206, may engage with the luxury property buyer to discuss and provide interactive information about the luxury real estate property granular components, property areas usage stories, and backstories. This engagement may be facilitated through various mediums, including a conversational AI system, an avatar, or a hologram, which may enable a dynamic and engaging dialogue with the consumer. The AI property interaction tool may be designed to interact with the buyer by leveraging advanced AI technologies, which may include natural language processing and machine vision, to ensure a seamless and personalized experience. The tool may be capable of understanding and responding to the buyer's inquiries, thereby enhancing the overall property buying experience. Additionally, the AI property interaction tool may work in conjunction with other components, such as the AI property analysis tool and the luxury property database system, to provide a comprehensive and integrated approach to real estate property search and matching. This collaboration may ensure that the buyer's practical and emotional needs are considered, thereby facilitating a more informed and satisfying property selection process. The AI property interaction tool may also be instrumental in presenting the best matching properties to the buyer, thereby aiding in the decision-making process. Through its interactive capabilities, the AI property interaction tool may significantly contribute to the efficiency and effectiveness of the AI-driven real estate property search and matching system.

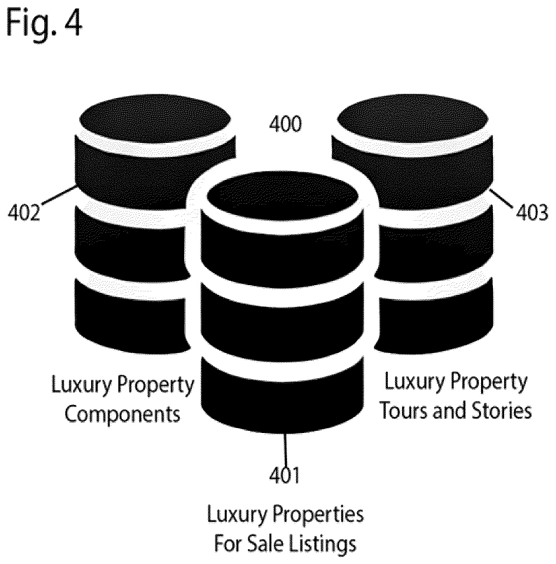

FIG. 4 illustrates the component 401, which may be referred to as the Luxury Properties For Sale Listings, within an AI-driven real estate property search and matching system. This component may be integral to the luxury property database system, which may store detailed information about properties for sale. The properties for sale listings may be analyzed and stored to facilitate AI-driven matching with potential buyers. The system may utilize machine vision and generative AI to analyze property data, including images, videos, and textual descriptions, to extract meaningful insights and identify granular property elements. This analysis may lead to the generation of granular property content, which may be used to match a buyer's desired property criteria with available properties. The properties for sale listings may be part of a larger interconnected database system that includes luxury property components and property tours and stories. This database system may capture and store real estate luxury property granular elements, facilitating future searches and matching with a buyer's desired property areas usage and backstories. The AI-driven property analysis tool may play a role in this process by analyzing vast amounts of data to determine the best matching properties. The AI property interaction tool may engage with the luxury property buyer to provide interactive information about the properties, potentially using avatars, conversational AI systems, or holograms to facilitate a dynamic and engaging dialogue. This interaction may enhance the buyer's experience by providing detailed insights into the properties, thereby addressing both the practical and emotional needs of the buyer. The luxury properties for sale listings component may thus be a part of the system, enabling a more personalized and efficient property search and matching process.

The luxury property components, identified as component 402, may serve as an element within the AI-driven real estate property search and matching system. This component may be part of a larger interconnected database system that is designed to store and manage detailed information about luxury properties. The luxury property components may include various granular elements of properties that are essential for facilitating AI-driven matching with potential buyers. These components may be stored in a luxury property database system, which may be configured to capture and store real estate luxury property granular elements, thereby enabling future search and matching with a buyer's desired property criteria.

The luxury property components may be analyzed by an AI property analysis tool, which may utilize machine vision to identify granular property elements from images and videos. This analysis may generate granular property content using a large language model and generative AI, which may be used to match a buyer's desired property areas with luxury real estate properties. The AI property analysis tool may analyze vast amounts of data, including images, videos, and textual descriptions, to extract meaningful insights about properties and create detailed property content. This process may help in determining the best matching properties for a buyer based on their desired property criteria.

Additionally, the luxury property components may be part of a system that includes an AI property interaction tool. This tool may engage with the luxury property buyer to discuss and provide interactive information about the luxury real estate property granular components. The interaction may involve the use of a conversational AI system, an avatar, or a hologram, which may facilitate a dynamic and engaging dialogue with the consumer. This engagement may help in providing a more personalized luxury property buying experience, addressing both the practical and emotional needs of buyers in the luxury real estate market.

Overall, the luxury property components, as part of component 402, may play a role in the Al-driven real estate property search and matching system by storing and managing detailed property data, facilitating AI-driven matching, and engaging with buyers to provide interactive information about properties.

The Luxury Property Tours and Stories component 403 may serve as an element within the Al-driven real estate property search and matching system. This component may be responsible for storing and managing detailed information about luxury property tours and stories, which may include visual and narrative elements that enhance the buyer's understanding and emotional connection to the properties. The component may work in conjunction with the luxury property database system to facilitate the storage of property tours and stories, thereby enabling a repository of property-related data.

The component 403 may utilize AI technologies to analyze and generate property content, which may include capturing and storing real estate luxury property granular elements and backstories in various formats. This process may involve the use of machine vision to identify property elements from images and videos, as well as generative AI to create detailed property content. The component may also facilitate the matching of a buyer's desired property criteria with luxury real estate properties by leveraging the stored property tours and stories, thereby determining the best matching properties for the buyer.

Furthermore, the component 403 may engage with the luxury property buyer by providing interactive information about the properties, which may include property areas usage stories and backstories. This interaction may be facilitated through various mediums such as a conversational AI system, an avatar, or a hologram, allowing for a dynamic and engaging dialogue with the consumer. The component may also integrate with other systems within the AI-driven property analysis and matching system to ensure a seamless and comprehensive property search experience that considers both the practical and emotional needs of the buyer.

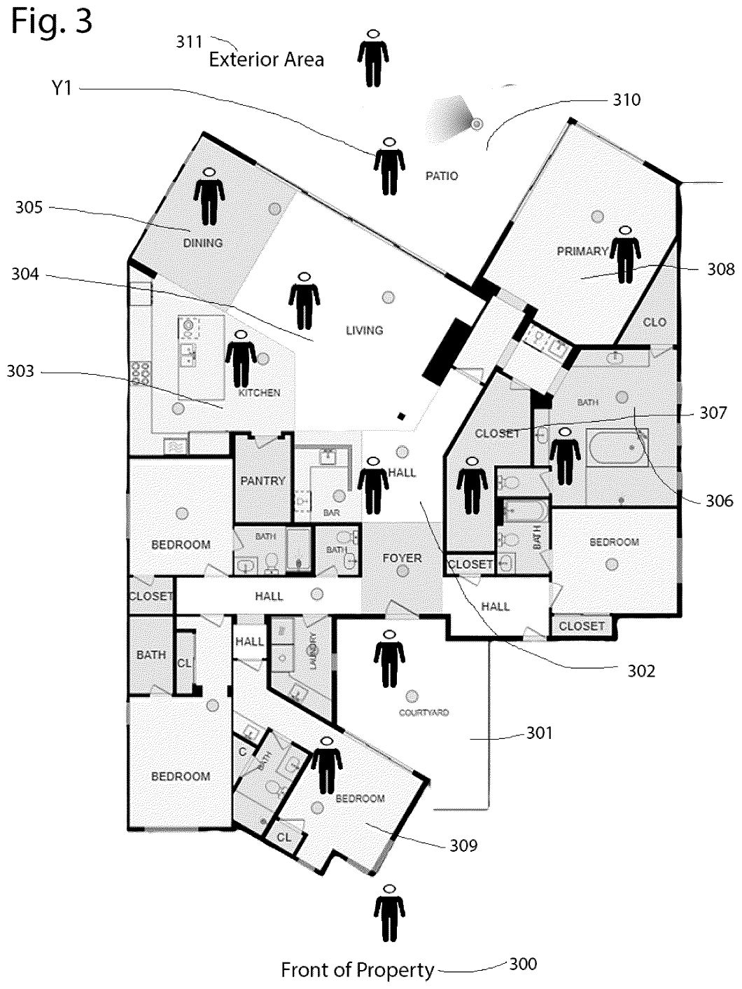

FIG. 3 is a detailed illustration of a property's floor plan, which is integral to the AI-driven real estate property search and matching system. This floor plan showcases various rooms and areas, including the kitchen, living room, dining area, bedrooms, and exterior spaces such as the patio and courtyard. The layout provides a view of the property's structure, highlighting key areas and their spatial relationships, which is crucial for the AI-driven property analysis and matching system to extract insights and identify granular property elements.

In the context of the AI-driven real estate property search and matching system, FIG. 3 serves as a visual representation that the AI property analysis tool can analyze using machine vision. By examining the spatial relationships and design flow depicted in the floor plan, the AI system can generate granular property content that aligns with a buyer's desired property criteria. This includes understanding the property's layout and how different areas can be utilized, which is essential for matching the buyer's desired property granular components and areas usage stories.

The AI-driven property interaction tool can further engage with the buyer by providing interactive information about the property's layout as shown in FIG. 3. This interaction may involve the use of a conversational AI system, an avatar, or a hologram to facilitate a dynamic dialogue, helping the buyer visualize how the space can be utilized according to their preferences. The detailed floor plan in FIG. 3 thus plays a role in enhancing the personalized luxury property buying experience by addressing both the practical and emotional needs of buyers in the luxury real estate market.

What is claimed is:

1. A computer-implemented method for searching and matching real estate properties to a buyer's desired property criteria using artificial intelligence (AI), the method comprising:
analyzing, by an AI-driven property analysis and matching system, property data including images, videos, and textual descriptions to extract insights and identify granular property elements;
generating, by the AI-driven property analysis and matching system, granular property content based on the analyzed property data;
receiving, by the AI-driven property analysis and matching system, a buyer's desired property criteria;
matching, by the AI-driven property analysis and matching system, the buyer's desired property criteria with properties based on the analyzed property data and generated property content to determine best matching properties; and
presenting, by the AI-driven property analysis and matching system, the best matching properties to the buyer.

2. A system for searching and matching real estate properties to a buyer's desired property criteria using artificial intelligence (AI), the system comprising:
an AI-driven property analysis and matching system configured to:
analyze property data including images, videos, and textual descriptions to extract insights and identify granular property elements,
generate granular property content based on the analyzed property data,
receive a buyer's desired property criteria,
match the buyer's desired property criteria with properties based on the analyzed property data and generated property content to determine best matching properties, and
present the best matching properties to the buyer;
an AI-driven property interaction system configured to engage with the buyer and provide interactive information about the properties; and
a luxury property database system configured to store luxury property components, properties for sale listings, property tours, and stories.

3. The method of claim 1, wherein the AI-driven property analysis and matching system utilizes machine vision to identify the granular property elements from the images and videos.

4. The method of claim 1, wherein the AI-driven property analysis and matching system generates the granular property content using a large language model and generative AI.

5. The method of claim 1, wherein the buyer's desired property criteria include desired property granular components, property areas usage stories, and backstories.

6. The method of claim 1, wherein the matching of the buyer's desired property criteria with properties is based on the analyzed property data, generated property content, and the buyer's desired property criteria to determine the best matching properties.

7. The method of claim 1, wherein presenting the best matching properties to the buyer includes providing property granular components, property areas usage stories, and backstories of the best matching properties.

8. The system of claim 2, wherein the AI-driven property analysis and matching system utilizes machine vision to identify the granular property elements from the images and videos.

9. The system of claim 2, wherein the AI-driven property analysis and matching system generates the granular property content using a large language model and generative AI.

10. The system of claim 2, wherein the buyer's desired property criteria include desired property granular components, property areas usage stories, and backstories.

11. The system of claim 2, wherein the AI-driven property analysis and matching system matches the buyer's desired property criteria with properties based on the analyzed property data, generated property content, and the buyer's desired property criteria to determine the best matching properties.

12. The system of claim 2, wherein the AI-driven property analysis and matching system presents the best matching properties to the buyer by providing property granular components, property areas usage stories, and backstories of the best matching properties.

13. The system of claim 2, wherein the AI-driven property interaction system engages with the buyer using at least one of a conversational AI system, an avatar, or a hologram.

14. The system of claim 2, wherein the AI-driven property interaction system facilitates a dynamic and engaging dialogue with the buyer to provide interactive information about the properties.

15. The system of claim 2, wherein the luxury property database system stores the luxury property components, properties for sale listings, property tours, and stories to facilitate search and matching with the buyer's desired property criteria.

16. The method of claim 1, further comprising storing, by a luxury property database system, luxury property components, properties for sale listings, property tours, and stories to facilitate search and matching with the buyer's desired property criteria.

17. The method of claim 1, further comprising engaging with the buyer, by an AI-driven property interaction system, to provide interactive information about the properties.

18. The method of claim 17, wherein the AI-driven property interaction system engages with the buyer using at least one of a conversational AI system, an avatar, or a hologram.

19. The method of claim 17, wherein the AI-driven property interaction system facilitates a dynamic and engaging dialogue with the buyer to provide interactive information about the properties.

20. The system of claim 2, wherein the AI-driven property analysis and matching system, the AI-driven property interaction system, and the luxury property database system work together to manifest an AI-driven real estate property search and matching system that considers both practical and emotional needs of the buyer.
